(19) United States
(12) Patent Application Publication
(10) Pub. No.: US 2017/0195176 A1
(43) Pub. Date: Jul. 6, 2017

(54) METHOD AND APPARATUS FOR RECOMMENDING DEVICE CONFIGURATION

(71) Applicant: Lenovo (Beijing) Limited, Beijing (CN)

(72) Inventors: Ke Ke, Beijing (CN); Jie Yang, Beijing (CN); Jun Liu, Beijing (CN)

(21) Appl. No.: 15/394,801

(22) Filed: Dec. 29, 2016

(30) Foreign Application Priority Data
Dec. 30, 2015 (CN) 201511023838.3

(51) Int. Cl. H04L 12/24; H04L 29/08

(52) U.S. Cl. CPC H04L 41/0813; H04L 41/0886; H04L 67/22; H04L 67/306

(57) ABSTRACT

An embodiment provides a method, including: acquiring, using a processor of an electronic device, current device configuration information and past device operation behavior information; determining, using the processor, one or more traits of a target user of the electronic device based on the current device configuration information and the past operation behavior information; and recommending, via an output element of the electronic device, a device configuration to the target user based on the current device configuration information and the user traits. Other embodiments are described and claimed.

### CLAIM FOR PRIORITY

This application claims priority to Chinese Application No. 201511023838.3, filed on Dec. 30, 2015, the contents of which are fully incorporated by reference herein.

### TECHNICAL FIELD

The subject matter relates to the field of product recommendation technology based on data analysis, and particularly relates to a device configuration recommendation method and device.

### BACKGROUND

At present, in the field of electronic devices, device recommendation has become an effective marketing approach. Whereas, one of the main purposes of device recommendation is to automatically recommend devices to users in order to meet their demands as much as possible.

The two main existing automatic recommendation methods are as follows: product positioning-based recommendation method and user cooperation-based recommendation method. The product positioning-based recommendation method refers to directly acknowledging the device in which the user is relatively more interested in from product positioning granularity by some device-related user behavior history. For instance, based on the user's web page browsing history, when browsing device marketing web pages or device information introduction web pages, realizing device recommendation. The user cooperation-based recommendation method refers to analyzing the devices that similar users are interested in. For example, by way of historical behaviors of such users, such as the web page browsing behaviors of students or colleagues, realization of a device recommendation may be made.

The above two recommendation methods can only realize product granularity device recommendation to the users according to their interests. The rather rough device positioning and recommended granularity fails to truly consider the device configuration demands of users and cause poor fit between the recommended device and user demands, thereby preventing the ability to effectively fulfill user demands.

### BRIEF SUMMARY

In summary, one aspect provides a method, comprising: acquiring, using a processor of an electronic device, current device configuration information and past device operation behavior information; determining, using the processor, one or more traits of a target user of the electronic device based on the current device configuration information and the past operation behavior information; and recommending, via an output element of the electronic device, a device configuration to the target user based on the current device configuration information and the user traits.

Another aspect provides an electronic device, comprising: an output element; a processor; a memory having instructions that are executed by the processor to: acquire, using the processor of an electronic device, current device configuration information and past device operation behavior information; determine, using the processor, one or more traits of a target user of the electronic device based on the current device configuration information and the past operation behavior information; and recommend, via the output element of the electronic device, a device configuration to the target user based on the current device configuration information and the user traits.

A further aspect provides a program product, comprising: a computer readable device having code embodied therewith, the code being executable by a processor and comprising: code that acquires, using a processor of an electronic device, current device configuration information and past device operation behavior information; code that determines, using the processor, one or more traits of a target user of the electronic device based on the current device configuration information and the past operation behavior information; and code that recommends, via an output element of the electronic device, a device configuration to the target user based on the current device configuration information and the user traits.

The foregoing is a summary and thus may contain simplifications, generalizations, and omissions of detail; consequently, those skilled in the art will appreciate that the summary is illustrative only and is not intended to be in any way limiting.

For a better understanding of embodiments, together with other and further features and advantages thereof, reference is made to the following description, taken in conjunction with the accompanying drawings, and the scope of the invention will be pointed out in the appended claims

### BRIEF DESCRIPTION OF THE SEVERAL VIEWS OF THE DRAWINGS

FIG. 1 is a flow diagram of an example method according to an embodiment.

FIG. 2 is a flow diagram of an example method according to an embodiment.

FIG. 3 is a flow diagram of an example method according to an embodiment.

FIG. 4 is a structural schematic diagram of an example device according to an embodiment.

FIG. 5 is a structural schematic diagram of an example device according to an embodiment.

FIG. 6 is a structural schematic diagram of an example device according to an embodiment.

### DETAILED DESCRIPTION

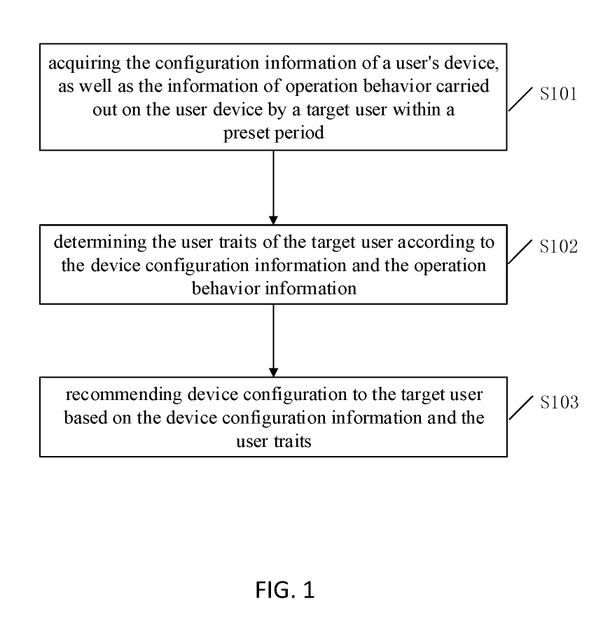

It will be readily understood that the components of the embodiments, as generally described and illustrated in the figures herein, may be arranged and designed in a wide variety of different configurations. Thus, the following more detailed description of the embodiments of the apparatus, system, and method, as represented in FIGS. 1 through 6 is not intended to limit the scope of the embodiments, as claimed, but is merely representative of selected embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, to provide a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

### Embodiment I

Referring to FIG. 1, shown is a flow diagram of an example device configuration recommendation method. At S101, the configuration information of a user's device is acquired, as well as the information of operation behavior carried out on the user device by a target user within a preset period. The device configuration information may comprise information regarding CPU (Central Processing Unit) main frequency, CPU model, memory size, video memory capacity, graphics card model, display size, display resolution, hard disk capacity and version of operating system. The operation behavior information may comprise a series of user behavior information, such as software operation information and the target user's web page browsing information on the user device, the target user's time spent on and use frequencies of the user device, and the position change information when the target user moves the user device.

The above user device configuration information and user operation behavior information can be gathered and obtained using gathering software pre-installed (for instance, installed before the device leaves the factory or based on the user's installation after the device leaves the factory) on the user device. The gathering software can adopt different information acquisition approaches according to different information types. For example, the hardware configuration information such as the CPU main frequency, CPU model, memory size, video memory capacity, graphics card model, and software operating information for a user starting or closing certain software can be obtained through the corresponding access interface provided by the operating system or device driver. For instance, an embodiment may obtain the corresponding device configuration information or software operating information through the operating system API (Application Programming Interface), the operating system registry, the operating system log and the device driver API. The position change information of a user device can be obtained through a GPS (Global Positioning System) sensor, and the periodic statistics, such as the frequency of a user touching the screen or using the mouse, can be obtained by recording the touch events or mouse-using events and the corresponding time, and then calculating the times of screen touch or mouse-using within a certain time period.

To facilitate standardized management, an embodiment uniformly sets the format of the gathered information as <information or behavior type, (operation) object, value and time>, wherein the “information or behavior type” and “(operation) object” are the necessary information items while the “value” and “time” may be assigned according to the specific information content or taken as null value.

For example: <hardware configuration, CPU main frequency, 2.6 HZ> represents that the CPU main frequency is 2.6 HZ; <hardware configuration, memory size, 4G> represents that the memory size is 4G; <hardware configuration, video memory, 1G> represents that the video memory capacity of CPU is 1G; < user operation, touch screen click, 150, 2015-11-20 10:00:00-2015-11-20 20:00:00> represents that the user used the touch screen for 150 times between 2015-11-20 10:00:00 and 2015-11-20 21:00:00; <software start, INTERNET EXPLORER, 2015-11-20 15:12:30> represents that the IE browser was opened on 2015-11-20 at 15:12:30; and <web page browse, JAVA program development, 2015-11-21 13:32:30> represents that the web page titled “JAVA program development” was browsed on 2015-11-21 at 13:32:30.

At S102 an embodiment determines the user traits of the target user according to the device configuration information and the operation behavior information. After gathering the user device configuration information and the user operation behavior information, the various gathered information can be integrated before being analyzed and processed, respectively. For instance, an embodiment analyzes the software that is most frequently used by users, and gathers statistics regarding the word frequency of the respective keywords for web page browsing so as to acquire the user traits of the target user. For instance, an embodiment determines the user has an application preference in a certain aspect, such as the preference of playing games, handling official businesses, watching videos or chatting on the user device, in order to acquire the user's occupation, purchasing ability, etc.

At S103 an embodiment recommends a device configuration to the target user based on the device configuration information and the user traits. This step will adjust the device configuration information of the current user device according to the user traits so as to acquire the to-be-recommended target device configuration information.

After acquiring the user traits, the user's actual device configuration requirements can be considered based on the acquired user traits such as the application preference in a certain aspect and user's purchasing ability, based on which the device configuration information meeting user's demand can be preliminarily developed.

Next, with reference to the generated device configuration information, the device configuration information of the current user device can be adjusted accordingly to acquire a set of device configuration information that better fits the user's actual configuration requirements, and to finally make recommendations on the device configuration by feeding back the device configuration information to the user device.

The device configuration recommendation method may be used for determining the user traits based on the device configuration information of the user's current device and user operation behavior information on the device within a preset period. Based on this, a suitable device configuration is recommended to users according to the user traits and the device configuration information of the current device. The user's device configuration demand based on user traits is considered in conjunction with the configuration information of the current device so as to provide a recommendation of the device configuration that meets the user's demand. Compared with the prior art which makes product recommendations based on user interest, embodiments take the user's configuration demands into consideration to realize a more granular recommendation that further meet user's demand.

### Embodiment II

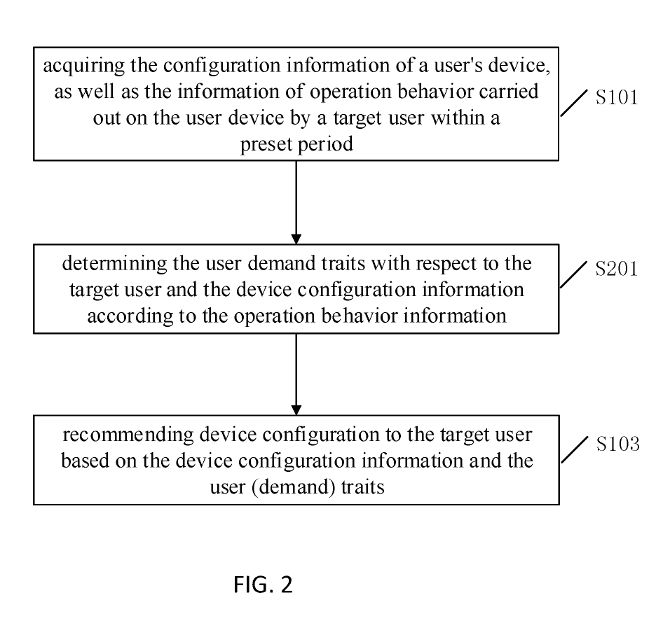

Referring to FIG. 2, the flow diagram of an example device configuration recommendation method provides step S102 can be realized through the following steps, i.e., S201 comprises determining the user demand traits with respect to the target user and the device configuration information according to the operation behavior information. This example embodiment may be applied to special users with prominent features in a certain aspect.

The target user can be analyzed in order to determine whether any prominent features on a certain aspect are present based on all the acquired user information, such as user operation behavior information. If the acquired user operation behavior information includes abundant and relatively more frequent use information for one/more types of game software, i.e., game-related information accounts for a considerably high ratio in total amount of information acquired, this user can be deemed, through analysis, as a heavy gaming enthusiast, such as a heavy 3D (3-Dimension) on-line gaming enthusiast or a large-scale single-player game enthusiast. If the acquired user operation behavior information includes the abundant and relatively more frequent use information for a certain type of development tool and abundant web page browsing information on software development, this user can be deemed, through analysis, as a programming enthusiast/programmer.

Since such users have more prominent features on a certain aspect, the device configuration can be specifically recommended for users according to the corresponding preferential features of users such as preferences of games and software development.

Based on the analysis of the user's prominent features on a certain aspect, users and their demand features related to the current device configuration can be further analyzed by combining user traits and the gathered current device configuration information and user operation behavior information. For instance, suppose that the user preference lies in large 3D on-line games and it is known that there are often lags during the gaming experience through the gathered user information. Then, it can be deduced that the user has a demand for higher specification graphics card configuration, higher CPU configuration or higher memory configuration etc. (compared to the current device configuration). Suppose that the user preference lies in software development and there are often issues of unresponsiveness or slow responsiveness that occur in an application. Then, it can be deduced that the CPU consumption or the memory utilization of the user is too high, thus the user may have a demand for higher CPU configuration or higher memory configuration (compared to the current device configuration).

The corresponding device configuration information may be generated for users based on users and their relevant demand features related to the current device configuration. For instance, to generate the information of the graphics card and CPU with higher spec. In accordance with the above description, the configuration information of the device is provided for the user's preference features on a certain aspect so as to use the generated device configuration information to adjust the configuration information of user's current device to recommend a set of device configuration information that meets the application preference on a certain aspect for users with such prominent features, such as gaming or programming enthusiasts, so as to meet user demand and further improve the quality of the recommendation.

### Embodiment III

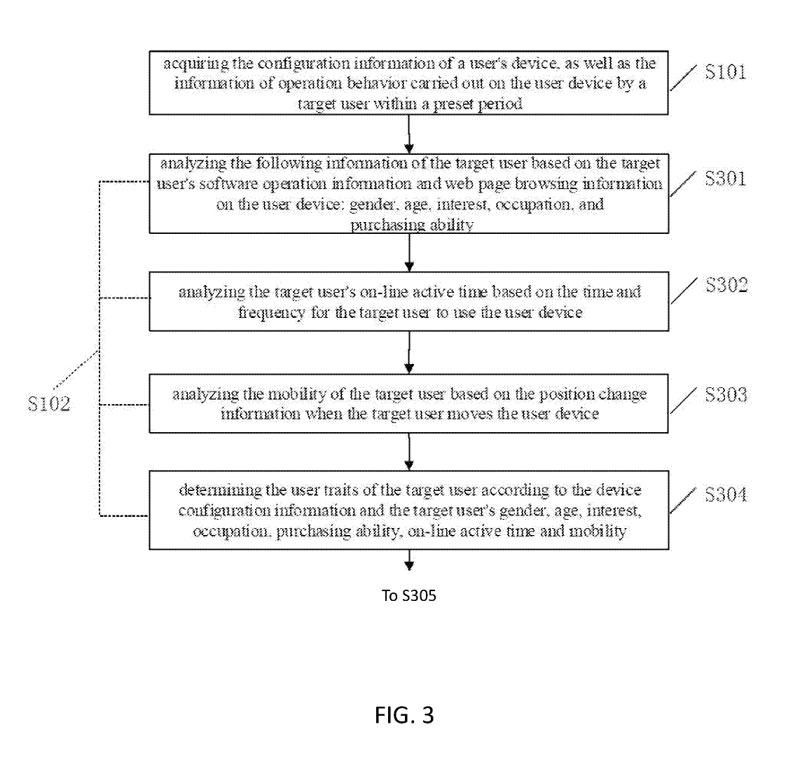

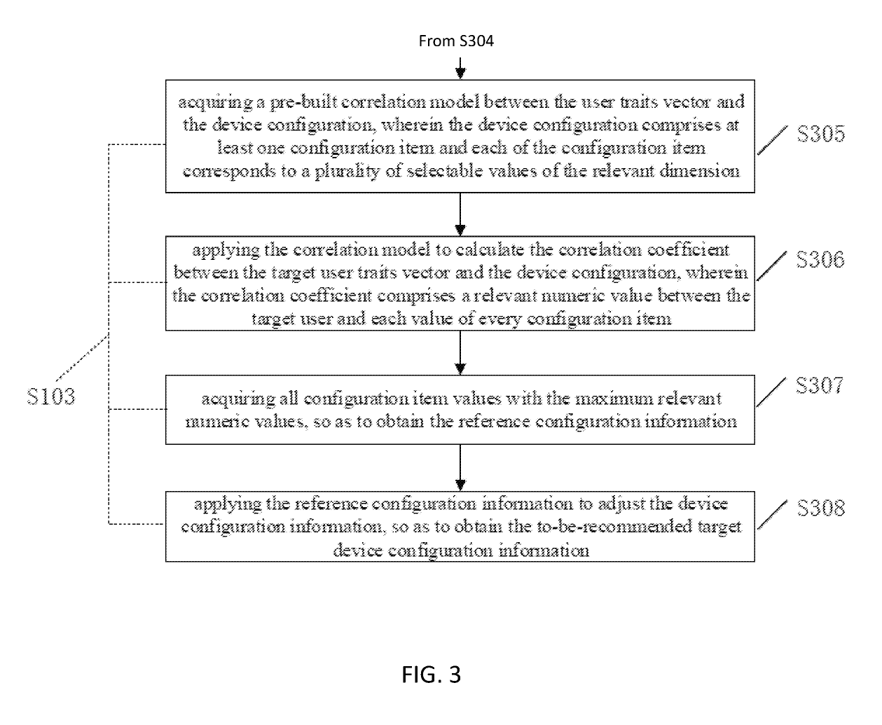

Referring to FIG. 3, the flow diagram of an example device configuration recommendation method provides that step S102 includes: at S301, analyzing the following information of the target user based on the target user's software operation information and web page browsing information on the user device: gender, age, interest, occupation, and purchasing ability. Then, at S302, an embodiment analyzes the target user's on-line active time based on the time and frequency for the target user to use the user device. At S303 the mobility of the target user is analyzed based on the position change information when the target user moves the user device. At S304, an embodiment determines the user traits of the target user according to the device configuration information and the target user's gender, age, interest, occupation, purchasing ability, on-line active time and mobility. This example embodiment may be applied to users without corresponding prominent features.

The ratio of the gathered various user operation behavior information, such as the operation information of each software and web page browsing information of various different content, is relatively balanced with respect to the total acquired information and cannot reflect the feature of the user on a certain aspect. An embodiment analyzes the configuration demands of the user by comprehensively considering multiple feature points of the user, such as gender, age, interest, occupation, and purchasing ability, thus realizing the device configuration recommendation on such basis.

Based on this, the user traits are specifically the integration of multiple feature points of the user. Thus, feature vectors may be employed to represent the user traits, e.g., F=(f₁, f₂, . . . fₙ), wherein 1-n correspond to n feature points of the user, such as gender, age, interest, occupation, purchasing ability, on-line active time and mobility. fᵢ is a feature component, and fᵢ=(s₁, s₂, . . . sᵢ) represents the probability of each value dimension in the i<th> feature point. Take “gender” as the first feature point of the user, for example, the value dimension of the gender being “female” or “male”. Thus f₁ represents the gender feature component of the user. f₁=(40%, 60%) represents that the probability of the user being a female is 40% and being a male is 60%.

The value of each feature component in the user traits vector in the relevant dimension may be specifically obtained based on analyzing the user operation behavior information gathered. The probabilities of the corresponding value dimensions of the feature points, such as gender, age, interest, occupation, and purchasing ability may be analyzed according to the software operation information and the web page browsing information of the user. The probability of on-line active time of the user in each value dimension is analyzed according to the target user's time spent on and use frequencies of the device. The probability of the mobility of the user in each value dimension (for example, mobility being divided into strong, medium and weak levels) is analyzed according to position change information when the user moves the user device.

The accuracy of the user traits analysis may be improved by specifically adopting a pre-trained classification model, the classification model being used to classify the classification targets. For instance, the classification model of the user interest can be trained based on a large number of key words from the user's browsed web pages in advance, followed by inputting the user's web page browsing information into the model. For example, inputting a series of key words to obtain the probability of all preset value dimensions (such as shopping, wealth management, gaming, music, etc.) of the user output by the model on the interest feature point.

The user traits vector may be appropriately and further adjusted according to the current device configuration information of the user based on the analysis of the user traits vector through the gathered user operation behavior information. For example, the purchasing ability value of the user can be appropriately adjusted based on the current device configuration condition so as to finally obtain the user traits vector that more accurately reflects user traits.

Based on this, and with reference to FIG. 3, step S103 may further include, at S305, acquiring a pre-built correlation model between the user traits vector and the device configuration. The device configuration comprises at least one configuration item and each of the configuration items correspond to a plurality of selectable values of the relevant dimension. At S306, an embodiment applies the correlation model to calculate the correlation coefficient between the target user traits vector and the device configuration, wherein the correlation coefficient comprises a relevant numeric value between the target user and each value of every configuration item. At S307, an embodiment acquires all configuration item values with the maximum relevant numeric values, so as to obtain the reference configuration information. At S308, an embodiment applies the reference configuration information to adjust the device configuration information, so as to obtain the to-be-recommended target device configuration information.

The device configuration comprises q configuration items, which can be characterized as d=(k₁, k₂, . . . k_{q}), wherein kᵢ represents any one of CPU main frequency, CPU model, memory size, video memory capacity, graphics card model, display size, display resolution and hard disk capacity, and each of them has selectable values of corresponding number, for example, the memory has five options, e.g., 1G, 2G, 4G, 8G, 16G.

The correlation model between the user traits vector and the device configuration is pre-built, which includes the correlation coefficient between the different values of the user traits vector and the device configurations. Therefore, after acquiring the target user traits vector based on the user operation behavior gathered, the correlation model may be used to calculate the correlation coefficient between the target user traits vector and the device configuration. The correlation coefficient comprises the relevant numeric value between the target user and each value of each configuration item. Then, all configuration item values with the maximum relevant numeric values are acquired, so as to obtain the reference configuration information. Based on this, the reference configuration information is applied to adjust the device configuration information of the user's current device so as to obtain the final to-be-recommended device configuration information. When compared with Embodiment II, this embodiment can recommend the device configuration to the users without prominent features by integrating various features of typical users.

From the user's perspective, it may be more preferable that a device that is more consistent with the required configuration is recommended. Thus, one or more devices having the most similar configuration information with the target device can be selected from a lot of device selections and be recommended to the user, so as to facilitate the reference and choice of the user.

### Embodiment IV

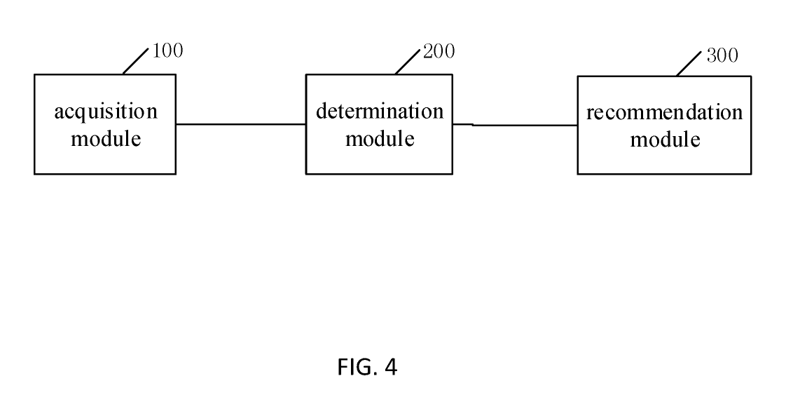

Referring to FIG. 4, the structural schematic diagram of an example device configuration recommendation comprises an acquisition module 100, used for acquiring device configuration information of the user device as well as operation behavior information carried out on the user device by a target user within a preset period. The device configuration information may comprise the information regarding CPU (Central Processing Unit) main frequency, CPU model, memory size, video memory capacity, graphics card model, display size, display resolution, hard disk capacity and version of operating system. The operation behavior information may comprise a series of user behavior information, such as software operation information and the target user's web page browsing information on the user device, the target user's time spent on and use frequencies of the user device, and the position change information when the target user moves the user device. The above user device configuration information and user operation behavior information can be gathered and obtained using the gathering software installed on the user device.

To facilitate standardized management, this embodiment uniformly sets the format of the gathered information as <information or behavior type, (operation) object, value and time>, wherein the “information or behavior type” and “(operation) object” are the necessary information items while the “value” and “time” can be assigned according to the specific information content or taken as null value, for example:

A determination module 200 may be used for determining the user traits of the target user according to the device configuration information and the operation behavior information. After gathering the user device configuration information and the user operation behavior information, the various gathered information can be integrated before being analyzed and processed respectively.

A recommendation module 300 may be used for recommending device configuration to the target user based on the device configuration information and the user traits. The recommendation module 300 comprises an adjustment and feedback unit, used for adjusting the device configuration information according to the user traits to obtain the to-be-recommended target device configuration information, and feeding back the target device configuration information.

After acquiring the user traits, the user's actual device configuration requirements may be considered based on the acquired user traits such as the application preference in a certain aspect and user's purchasing ability, based on which device configuration information that meets the user's demand can be preliminarily developed.

Next, with reference to the generated device configuration information, the device configuration information of the current user device may be adjusted accordingly to acquire a set of device configuration information that better fits the user's actual configuration requirements, and to finally make recommendations on the device configuration by feeding back the device configuration information to the user device.

The device configuration recommendation device provided may be used for determining the user traits based on the device configuration information of the user's current device and user operation behavior information on the device within a preset period. Based on this, a suitable device configuration is recommended to users according to user traits and the device configuration information of the current device. The device analyzes the user's device configuration demand based on user traits, in conjunction with the configuration information of the current device so as to provide a recommendation of the device configuration that meets the user's demand. Compared with the prior art which makes product recommendations based on user interest, the device takes a user's configuration demands into consideration to realize a more granular recommendation that further meets the user's demand.

### Embodiment V

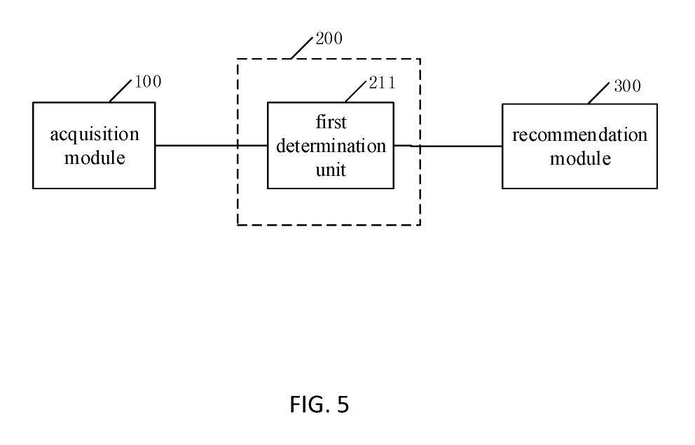

Referring to FIG. 5, shown is a structural schematic diagram of an example device configuration recommendation device. The determination module 200 comprises a first determination unit 211, used for determining the user demand traits with respect to the target user and the device configuration information according to the operation behavior information. This example embodiment may be applied to special users with prominent features in a certain aspect.

Since such users have more prominent features on a certain aspect, a device configuration may be recommended for users according to the corresponding preferential features of users such as preferences of games and software development.

Based on this, the corresponding device configuration information can be generated for users based on users and their relevant demand features related to the current device configuration

### Embodiment VI

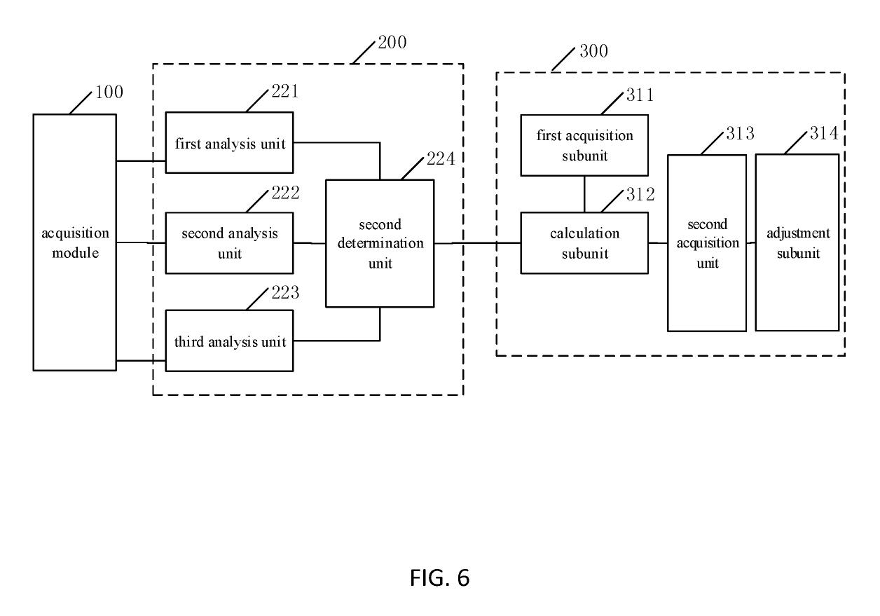

Referring to FIG. 6, shown is a structural schematic diagram of an example device configuration recommendation device. The determination module 200 comprises a first analysis unit 221, used for analyzing the following information of the target user based on the target user's software operation information and web page browsing information on the user device: gender, age, interest, occupation, and purchasing ability; a second analysis unit 222, used for analyzing the target user's on-line active time based on the target user's time spent on and use frequencies of the user device; a third analysis unit 223, used for analyzing the mobility of the target user based on the position change information when the target user moves the user device; and a second determination unit 224, used for determining the user traits of the target user according to the device configuration information, and the target user's gender, age, interest, occupation, purchasing ability, on-line active time and mobility. This example embodiment may be applied to users without corresponding prominent features.

The ratio of the gathered various user operation behavior information, such as the operation information of each software and web page browsing information of various different content, is relatively balanced with respect to the total acquired information and cannot reflect the feature of the user on a certain aspect. This embodiment analyzes the configuration demands of the user by comprehensively considering multiple feature points of the user, such as gender, age, interest, occupation, and purchasing ability, thus realizing the device configuration recommendation on such basis.

Referring to FIG. 6, the recommendation module 300 comprises a first acquisition subunit 311, used for acquiring the pre-built correlation model between the user traits vector and the device configuration, wherein the device configuration comprises at least one configuration item and each of the configuration item corresponds to a plurality of selectable values of the relevant dimension.

The recommendation module 300 comprises a calculation subunit 312, used for applying the correlation model to calculate the correlation coefficient between the target user traits vector and the device configuration, wherein the correlation coefficient comprises a relevant numeric value between the target user and each value of every configuration item.

The recommendation module 300 comprises a second acquisition unit 313, used for acquiring all configuration item values with the maximum relevant numeric values, so as to obtain the reference configuration information; and an adjustment subunit 314, used for applying the reference configuration information to adjust the device configuration information, so as to obtain the target device configuration information.

Those skilled in the art should realize that an embodiment may be provided as a method, a system or a computer program product. Therefore, various embodiments may use forms of a full hardware embodiment, a full software embodiment, or an embodiment that is a combination of software and hardware. Furthermore, the embodiments may use forms of computer program products implemented on one or more computer storage media or devices (including, but not limited, to a magnetic disk memory device, a CD-ROM device, an optical memory device or the like), which include a computer program code.

Various embodiments are described with reference to flow diagrams and/or block diagrams. It should be understood that each flow and/or block in the flow diagrams and/or block diagrams and a combination thereof may be implemented by computer program instructions. These computer program instructions may be provided for a processor or processors of programmable data processing device(s) to generate a machine, so as to generate an apparatus configured to implement designated functions in one or more flows of a flow diagram and/or one or more blocks of a block diagram by instructions, executed by a processor.

These computer program instructions may also be stored in a computer-readable storage device such as a computer memory that can guide a computer or other programmable data processing device(s) to work in a particular way, so that the instructions stored in the computer-readable storage device or memory generate a manufactured product including instructions that implement the designated functions in one or more flows of a flow diagram and/or one or more blocks of a block diagram. In the context of this document, a computer-readable memory or storage device is not a signal and “non-transitory” includes all media except signal media.

The computer program instructions may also be loaded on a computer or other programmable data processing devices, to execute a series of operating steps on the computer or other programmable device(s) to produce a computer executed process, so that instructions executed on the computer or other programmable device(s) provide steps that implement designated functions in one or more flows of a flow diagram and/or one or more blocks of a block diagram.

Although example embodiments have been described, those skilled in the art may make additional alterations and modifications on these embodiments. Therefore, the appended claims are intended to be interpreted as covering the example embodiments, including equivalents and all alterations and modifications falling within the ability of those having skill in the art.

It will be apparent to those skilled in the art that various modifications and variations can be made to the example embodiments without departing from the spirit and scope of the disclosure. In view of the foregoing, the non-limiting example embodiments are to be construed as covering modifications and variations thereof.

What is claimed is:

1. A method, comprising:
acquiring, using a processor of an electronic device, current device configuration information and past device operation behavior information;
determining, using the processor, one or more traits of a target user of the electronic device based on the current device configuration information and the past operation behavior information; and
recommending, via an output element of the electronic device, a device configuration to the target user based on the current device configuration information and the user traits.

2. The method according to claim 1, wherein the one or more traits comprise user demand traits regarding resource utilization of resources of the electronic device.

3. The method of claim 2, wherein the resource utilization is selected from the group consisting of CPU utilization and memory utilization.

4. The method according to claim 1, wherein the operation behavior information comprises: software operation information of the target user and web page browsing information of the target user on the electronic device, a time spent on the electronic device by the target user, a frequency of use of the electronic device by the target user, and position change information determined in response to the target user moving the electronic device.

5. The method of claim 4, wherein the one or more traits comprise a trait selected from the group consisting of gender, age, interest, occupation, and purchasing ability.

6. The method of claim 4, wherein the determining comprises:
analyzing on-line active time of the target user based on time spent on and use frequencies of the electronic device by the target user.

7. The method of claim 4, wherein the determining comprises:
analyzing the position change information to determine a mobility trait of the target user.

8. The method according to claim 1, wherein recommending comprises:
automatically adjusting the device configuration according to one or more traits of the target user.

9. The method according to claim 1, comprising:
characterizing the target user using a user traits vector,
acquiring a pre-built correlation model that correlates the user traits vector and the device configuration, wherein the device configuration comprises at least one configuration item, and the at least one configuration item corresponds to a plurality of selectable values of a dimension;
applying the correlation model to calculate a correlation coefficient between the traits vector and the device configuration, wherein the correlation coefficient comprises a numeric value between the target user and each value of the at least one configuration item;
acquiring the at least one configuration item value with a maximum relevant numeric value so as to obtain reference configuration information; and
applying the reference configuration information to adjust the device configuration information so as to obtain target device configuration information;
wherein the device configuration recommended is based on the target device configuration information.

10. An electronic device, comprising:
an output element;
a processor;
a memory having instructions that are executed by the processor to:
acquire, using the processor of an electronic device, current device configuration information and past device operation behavior information;
determine, using the processor, one or more traits of a target user of the electronic device based on the current device configuration information and the past operation behavior information; and
recommend, via the output element of the electronic device, a device configuration to the target user based on the current device configuration information and the user traits.

11. The electronic device according to claim 10, wherein the one or more traits comprise user demand traits regarding resource utilization of resources of the electronic device.

12. The electronic device of claim 11, wherein the resource utilization is selected from the group consisting of processor utilization and memory utilization.

13. The electronic device according to claim 10, wherein the operation behavior information comprises: software operation information of the target user and web page browsing information of the target user on the electronic device, a time spent on the electronic device by the target user, a frequency of use of the electronic device by the target user, and position change information determined in response to the target user moving the electronic device.

14. The electronic device of claim 13, wherein the one or more traits comprise a trait selected from the group consisting of gender, age, interest, occupation, and purchasing ability.

15. The electronic device of claim 13, wherein the processor executes instructions to determine the one or more traits by:
analyzing on-line active time of the target user based on time spent on and use frequencies of the electronic device by the target user.

16. The electronic device of claim 13, wherein the processor executes instructions to determine the one or more traits by:
analyzing the position change information to determine a mobility trait of the target user.

17. The electronic device according to claim 10, wherein the processor executes instructions to:
automatically adjusting the device configuration according to one or more traits of the target user.

18. The electronic device according to claim 10, wherein the processor executes instructions to:
characterize the target user using a user traits vector,
acquire a pre-built correlation model that correlates the user traits vector and the device configuration, wherein the device configuration comprises at least one configuration item, and the at least one configuration item corresponds to a plurality of selectable values of a dimension;
apply the correlation model to calculate a correlation coefficient between the traits vector and the device configuration, wherein the correlation coefficient comprises a numeric value between the target user and each value of the at least one configuration item;
acquire the at least one configuration item value with a maximum relevant numeric value so as to obtain reference configuration information; and
apply the reference configuration information to adjust the device configuration information so as to obtain target device configuration information;
wherein the device configuration recommended is based on the target device configuration information.

19. The electronic device of claim 10, wherein the device configuration recommended is an adjusted device configuration that adjusted the electronic device to emulate a customized electronic device designed for gaming.

20. A program product comprising:
a computer readable device having code embodied therewith, the code being executable by a processor and comprising:
code that acquires, using a processor of an electronic device, current device configuration information and past device operation behavior information;
code that determines, using the processor, one or more traits of a target user of the electronic device based on the current device configuration information and the past operation behavior information; and
code that recommends, via an output element of the electronic device, a device configuration to the target user based on the current device configuration information and the user traits.
